(19) United States
(12) Patent Application Publication
(10) Pub. No.: US 2018/0046064 A1
(43) Pub. Date: Feb. 15, 2018

(54) LIGHT DIFFUSER AND SCREEN PROTECTOR

(71) Applicant: GFIP HOLDINGS LLC, Carson City, NV (US)

(72) Inventor: GARY FONG, KELOWNA (CA)

(21) Appl. No.: 15/237,321

(22) Filed: Aug. 15, 2016

(51) Int. Cl. G03B 15/06; G03B 11/04; G03B 17/12

(52) U.S. Cl. CPC G03B 15/06; G03B 17/12; G03B 11/046

(57) ABSTRACT

A diffuser for a camera, the diffuser including a base configured to be accommodated on a hotshoe assembly of the camera; a body configured to cover a display screen of the camera and also configured to act as a light diffuser; and a bridge being directly coupled to and extending between the base and the body; wherein the diffuser can be oriented in a first orientation in the hotshoe assembly such that the body extends away from the camera to act as a light diffuser or in a second orientation in the hotshoe assembly such that the body covers a display screen of the camera.

### FIELD

The present invention relates to photographic light diffusers. Particularly, the present invention relates to a photographic light diffuser that can also be used to protect a camera display screen.

### BACKGROUND

Most digital cameras include a display screen that is configured to display photos that are stored on the camera's memory card and also to display technical information about the camera and memory card, including shutter speed, f-stop, the amount of memory left, and other features. The display screen is usually a transparent material such as glass or rigid plastic resin that is vulnerable to breakage and to being scratched, particularly during transportation of the camera. For example, if a photographer carries the camera in a large bag with other equipment, such other equipment may scratch or crack the display screen. Display covers for camera display screens are generally known. However, such display covers often “snap to” a periphery of the display screen by a simple latch system on the display cover than engages a portion of the periphery of the screen. Because the coupling attachment of the display cover to the display screen may be relatively weak, such display covers can be accidently detached from the display screen during transport of the camera upon contact with accompanying equipment.

Additionally, many cameras also include both a built-in flash that is permanently secured to the camera body as well as a so-called “hotshoe assembly” configured to accommodate an external flash, usually being significantly larger than the built-in flash. The hotshoe assembly is typically a metal bracket located on top of a camera that contains electrical contacts for electrically connecting an external device to the camera.

Light produced by camera flashes may, in some situations, be too bright or direct, causing the subjects of the photograph to appear less natural or discolored. Accordingly, diffuse lighting accessories are commonly used to provide soft lighting effects in photographs. To achieve a diffuse lighting effect, light can be either directly or indirectly passed through a semi-transparent material, or it may be reflected off a material which will cause it to scatter somewhat. Such diffuse lighting is commonly produced by light sources which are remote from the camera. Typically, such light diffusers are provided by stationary screens, umbrellas, soft boxes, and the like. Such devices provide excellent lighting effects in fixed studio settings where there is no need to transport the lighting equipment including the diffusers from place to place.

Each particular shot to be lighted dictates the type and intensity of light needed to properly illuminate the subject. In some situations direct light from a light source without any alteration may be required. In other situations direct lighting may be too strong or cast overly distinct shadows, in which case a more diffuse light is desirable. In still other cases, an even more indirect diffuse light may be needed to create the proper lighting effect. It is important to have a certain amount of uniformity in the lighting used to illuminate the subject. This uniformity may be achieved using typical stationary diffusers provided that the equipment is of good quality and is employed in the proper fashion.

While the lighting equipment described above provides good lighting effects in a fixed studio setting, it can be inconvenient if not impossible to use such stationary lighting accessories outside of the photography studio. For shoots which require the photographer to be mobile, especially shoots where the photographer must capture action shots or cannot otherwise pose his subject, a small portable diffuser may be used which attaches directly to the camera itself. Such a light diffuser may be placed directly over a built-in camera to provide a semi-transparent barrier to clear light transmission. Known diffusers exist which are small and portable with the camera and flash itself, and these diffusers are used by photographers in shoots where it is impractical to employ fixed lighting equipment. However, known portable diffusers for use with on-camera flashes are less than ideal in terms of the quality of lighting produced. These diffusers tend to create hotspots and may also leave noticeable, undesirable shadows.

### SUMMARY

A diffuser for a camera, the diffuser including a base configured to be accommodated on a hotshoe assembly of the camera; a body configured to cover a display screen of the camera and also configured to act as a light diffuser; and a bridge being directly coupled to and extending between the base and the body; wherein the diffuser can be oriented in a first orientation in the hotshoe assembly such that the body extends away from the camera to act as a light diffuser or in a second orientation in the hotshoe assembly such that the body covers a display screen of the camera.

In one embodiment, the body has a first surface that is planar and a second opposing surface that has at least one protrusion thereon, and further, in the second orientation the first surface of the body is configured to directly contact the display screen of the camera. Further, in one embodiment, the body is configured to entirely cover the display screen.

In one embodiment, the base includes a first plate, a second plate, and a block between the first and second plates, wherein a width of the first and second plates is greater than a width of the block. Outer longitudinal edges of the first and second plates may define first and second flanges, respectively. Further, the first and second flanges and a portion of the block define a channel being configured to accommodate the hotshoe assembly.

In one embodiment, the bridge is coupled to one longitudinal end of the base. Additionally, a longitudinal axis of the base may extend in a first direction and a longitudinal axis of the body and the bridge may extend in a second direction substantially perpendicularly to the first direction. As such, the diffuser may form an L-shape in cross-section.

In one embodiment, the bridge has a notch configured to accommodate a protrusion on the camera body.

### BRIEF DESCRIPTION OF THE DRAWINGS

FIG. 1 is a perspective view of a diffuser according to an embodiment of the present invention.

FIG. 2 is a front view of the diffuser of FIG. 1.

FIG. 3 is a side view of the diffuser of FIG. 1.

FIG. 4 is a rear view of the diffuser of FIG. 1.

FIG. 5 is a perspective view of the diffuser of FIG. 1 coupled to a camera in a first orientation in which the diffuser acts as a light diffuser.

FIG. 6 is a perspective view of the diffuser of FIG. 1 coupled to a camera in a second orientation in which the diffuser acts a screen cover.

FIG. 7 is a perspective view of another embodiment of the diffuser and also illustrates how the diffuser of FIG. 1 can be accommodated onto a camera hotshoe assembly in the second orientation.

FIG. 8 is a rear view of another embodiment of a diffuser according to the present invention.

### DETAILED DESCRIPTION

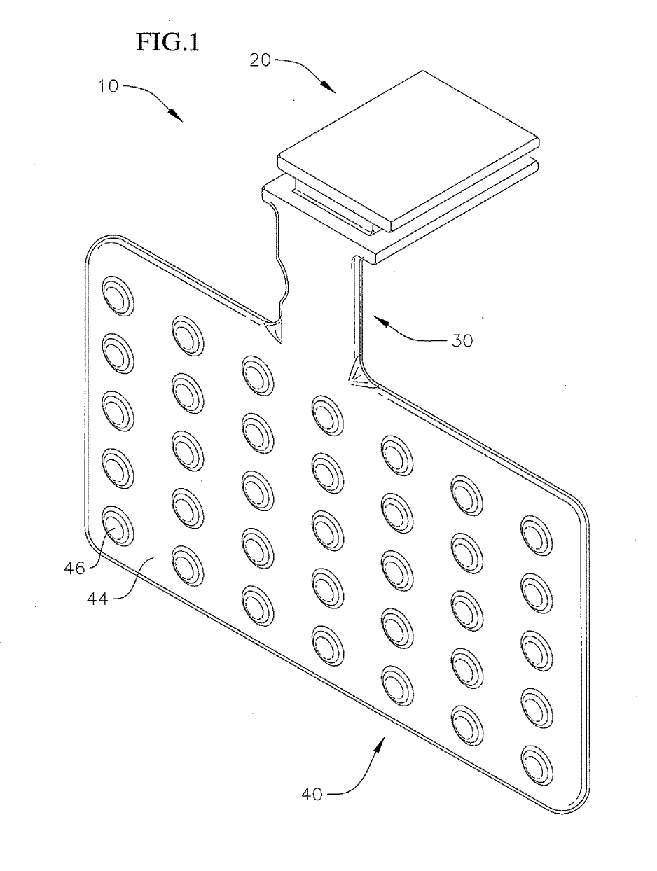

Embodiments of the present invention, as shown with respect to FIGS. 1-6, are generally directed to a portable light diffuser 10 that can also be used as a display screen cover. In other words, the light diffuser 10 can be moved between a first orientation in which the light diffuser can be mounted in front of or proximate to a flash to act as a light diffuser and a second orientation in which the light diffuser can be securely mounted to the camera to cover a display screen on a camera.

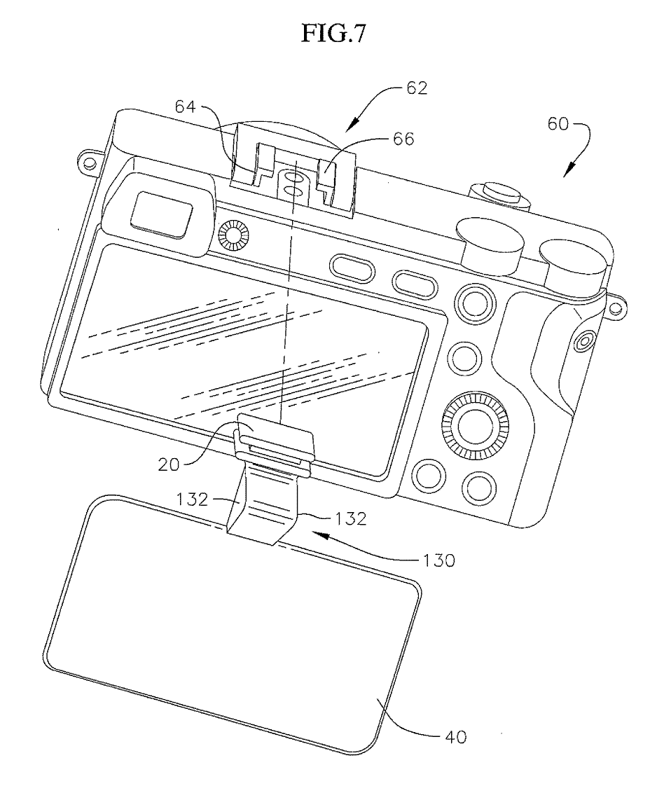

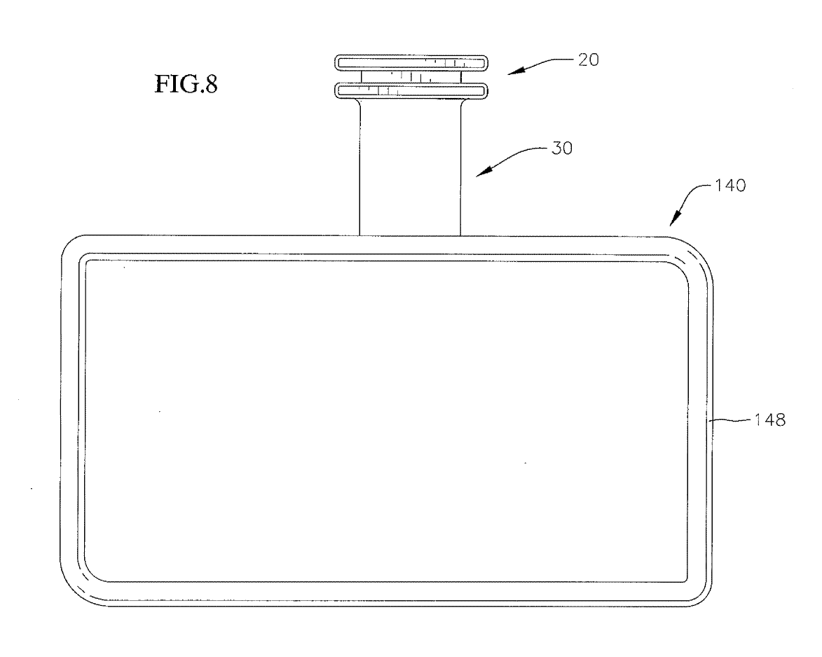

As will be described with reference to the drawings in more detail below, the light diffuser 10 is configured to be securely mounted to a hotshoe assembly 62 located on top of a camera 60 (FIG. 7). As noted above, the hotshoe assembly 62 typically includes a metal bracket that contains electrical contacts to electrically connect an external flash to the camera. Usually, the metal bracket includes two opposing side walls 64 that extend away from the camera body to define an exterior portion of the hotshoe assembly, wherein a top portion 66 of each of the side walls is bent substantially perpendicularly from the rest of the side wall to extend towards the opposing sidewall. The side walls 64 configured in this orientation allow accommodation of a base of an external flash therein so that the external flash can be securely mounted to the camera and used therewith. As described in more detail below, the diffuser 10 is configured to be accommodated by this side wall configuration.

In one embodiment, the diffuser 10 comprises a material such as resin plastic from which the diffuser can be molded. The material may be rigid enough to be securely coupled to the hotshoe assembly 62, but flexible enough so as to bend rather than snap into two pieces upon impact. Further, the material may be entirely transparent or partially transparent, or even mostly opaque if desired. Specifically, the diffuser 10 may comprise a translucent milky-white resin plastic, but is not limited thereto. As will be appreciated, the diffuser 10 is relatively simple to manufacture by being molded from a single mold to produce a single integral component. However, the diffuser 10 could also be made modularly as separate pieces and then connected together.

With reference to FIG. 1, the diffuser 10 includes a base 20 configured to be directly coupled to a camera 60, a body 40 configured to act as a light diffuser or a display screen cover depending on the orientation of the diffuser 10, and a bridge 30 located between the base 20 and the body 40 to thereby connect the base and the body together.

In one embodiment, the base 20 is configured to be slidingly couplable to the hotshoe assembly 62 of the camera 60. Particularly, the base 20 may be configured to be slidingly coupled to the hotshoe assembly such that the diffuser 10 can be coupled to the hotshoe assembly 62 facing in a first direction (i.e., facing forwards) or in a second direction (i.e., facing backwards). Further, the base 20 may be configured to be coupled to the hotshoe assembly 62 such that the body 40 extends upward or downward from the hotshoe assembly 62.

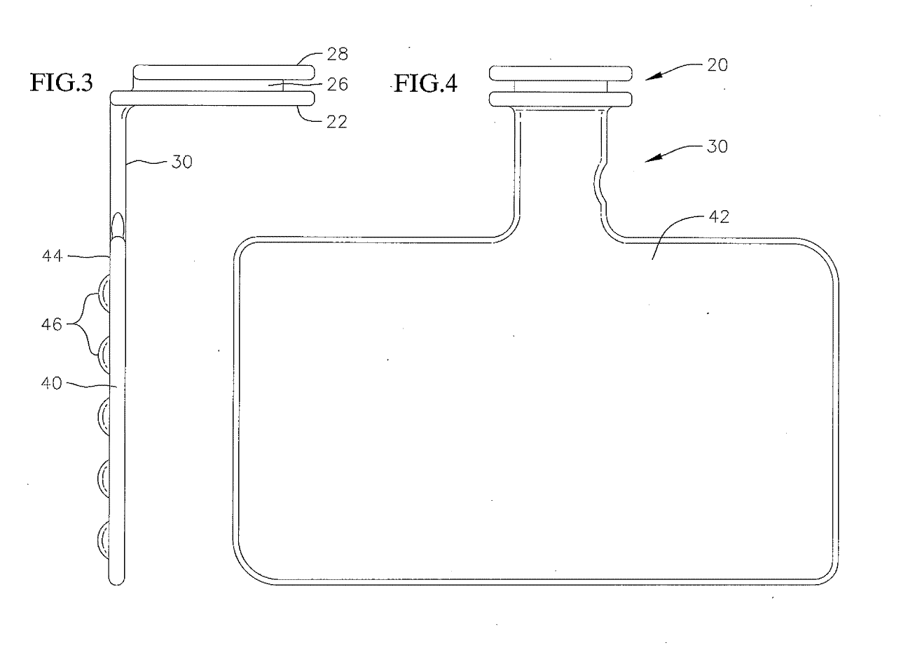

Accordingly, the base 20 comprises a substantially planar first plate 22 directly coupled to the bridge 30. In one embodiment as shown in FIG. 3, the base 20 is coupled to the bridge 30 at or near one longitudinal end of the bridge such that the diffuser is substantially L-shaped. However, it will be appreciated that the bridge 30 may also be located closer to a center of the base 20 if desired. Further, the first plate 22 is couplable to the bridge 30 such that an angle between the bridge 30 and the first plate 22 is substantially 90 degrees. However, an angle between the bridge 30 and the base 20 is not limited to 90 degrees, but rather can be any angle that allows the base 20 to be coupled to the hotshoe assembly 62 while allowing the body 40 to act in its desired role as a light diffuser or a screen cover.

In one embodiment, a width of the first plate 22 is greater than a width of the bridge 30 such that opposing peripheral longitudinal edges of the first plate 22 form a first flange 24 extending along an entire length of both sides of the base 20. As will be appreciated, the first flange 24 acts in cooperation with other portions of the base to secure the diffuser 10 within the hotshoe assembly as will be described in more detail below.

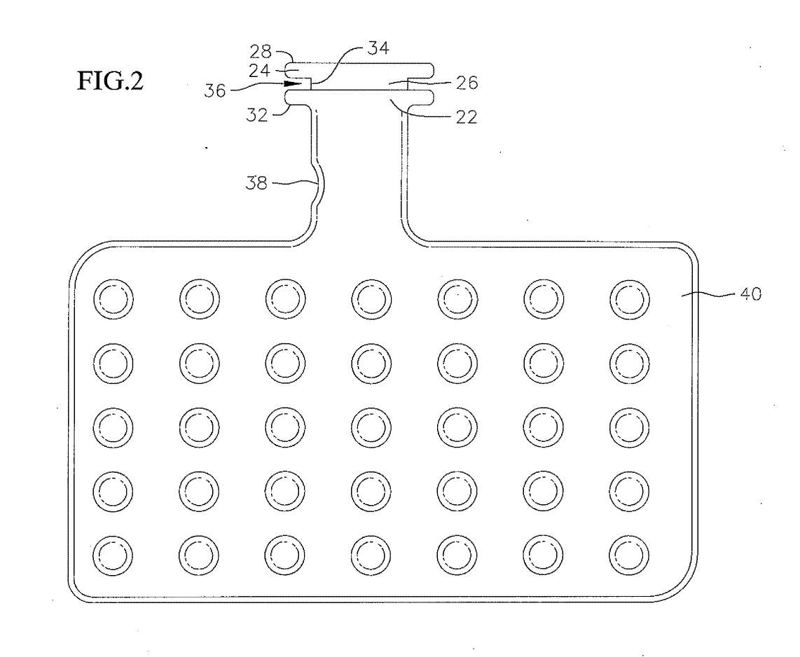

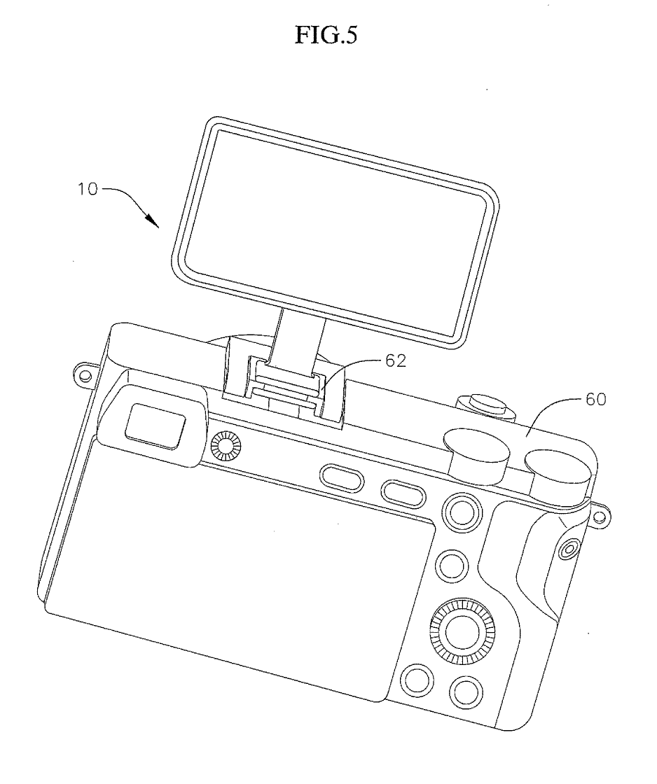

A block 26 is coupled to the first plate 22 and extends in a direction away from the bridge 30. The block 26 is located between and directly contacts the first plate 22 and a second plate 28 located on an opposite side of the block 26. As shown, for example, in FIGS. 2 and 4, a width of the second plate 28 is greater than a width of the bridge 30 such that opposing peripheral longitudinal edges of the second plate 28 form a second flange 32 extending along an entire length along both sides of the base 20.

Accordingly, the first flange 24 and the second flange 32 along with a peripheral surface 34 of the block extending between the flanges define opposing channels 36 running along a longitudinal axis of the base 20. The channels 36 are each configured to accommodate a respective bent upper portion 66 of one of the side walls 64 of the hotshoe assembly 62.

While a particular length of the base 20 is not critical, in one embodiment, the length of the base 20 should be long enough such that when the diffuser 10 is used in a second orientation as a screen protector (described below), the base 20 can be securely accommodated onto the side walls 64 of the hotshoe assembly 62 when the body 40 covers the display screen 68. In other words, the base 20 is long enough such that when the body 40 of the diffuser 10 covers the display screen 68 of the camera 60, the base 20 extends a sufficient distance into the hotshoe assembly 62 to secure the diffuser to the camera while allowing the body 40 to remain flat against the display screen. In one embodiment, a length of the base 20 is substantially equal to a length of the hotshoe assembly 62.

The bridge 30 is coupled between the base 20 and the body 40 of the diffuser 10. Particularly, one longitudinal end of the bridge 30 is coupled to the first plate 22 of the base 20 and the other longitudinal end of the bridge 30 is coupled to a peripheral edge of the body 40. As can be seen particularly in FIG. 2, a width of the bridge 30 is less than a width of the flanges 24, 32 of the base 20 as well as less than a width of the body 40.

In one embodiment, with continued reference to FIG. 2, the bridge 30 may have a structure to accommodate certain camera features and thereby be able to lie flat against a surface of the camera without interference from such features. For example, in one embodiment, the bridge 30 may include at least one notch 38 that is sized so as to prevent interference with a rotary button located adjacent the viewfinder and protruding from the camera body. It will be appreciated that the notch 38 could be omitted from the bridge 30 or that the bridge 30 may include more than one notch to accommodate particular camera features also protruding from the camera body.

In another embodiment, as shown in FIG. 7, the bridge 130 may be have parallel sides and may, for example, have a width thin enough to prevent interference with any camera body protrusions. Additionally, the bridge 130 may include a finger grip 132 which is a side wall that protrudes outwardly from the bridge away from the camera body. The finger grip 132 is dimensioned to allow a user to grasp the grip to allow easier removal of the diffuser from the hotshoe assembly 60. As shown, a pair of finger grips 132 having an arc-shape are provided in lateral sides of the bridge 130. However, it will be appreciated that a single grip (or more than two) may also be provided and that the grip may be centrally located on the bridge.

The body 40 of the diffuser 10 extends away from the bridge 30 and the base 20. As shown in the figures, the body 40 is substantially rectangular and is configured such that it can act as both a light diffuser and as a screen cover. In one embodiment as shown in FIGS. 3 and 4, the body 40 has at least one substantially planar surface 42 that is configured to be adjacent to and contact the display screen when the diffuser 10 is in the second orientation. Accordingly, the body 40 can cover the display screen 68 to thereby protect the screen. In one embodiment, the body 40 can be dimensioned such that edges of the body 40 substantially correspond to edges of the display screen. Accordingly, the body 40 can completely cover the display screen 68 without any of the screen being exposed.

In one embodiment as shown in FIGS. 1 and 3, one surface 44 of the body 40, for example, the surface opposite to the planar surface, may include one or more protrusions 46 thereon. As will be appreciated, the non-perpendicular angles created by the at least one protrusion 46 serve to further redirect and diffuse light generated by the flash to create an even softer appearance of light on a photograph. In one embodiment, the surface 44 of the body 40 includes a plurality of circular protrusions 46 spread substantially evenly throughout the surface 44. However, the number, shape, size, and location of the protrusions 46 is not limited to those described herein.

Further, in one embodiment as shown in FIG. 8, a body 140 may have a peripheral edge 148 that is thicker than a remainder of the body such that the peripheral edge covers side edges of the screen as well as the planar face of the screen. In one embodiment, a thickness of the peripheral edge 148 is about 1.5 to 10 times thicker than a thickness of the remainder of the body 140. Accordingly, the body 140 can even more effectively surround a screen that protrudes from the camera body and can also prevent the body 140 from being dislodged with respect to the screen due to the surrounding edges of the body abutting the screen.

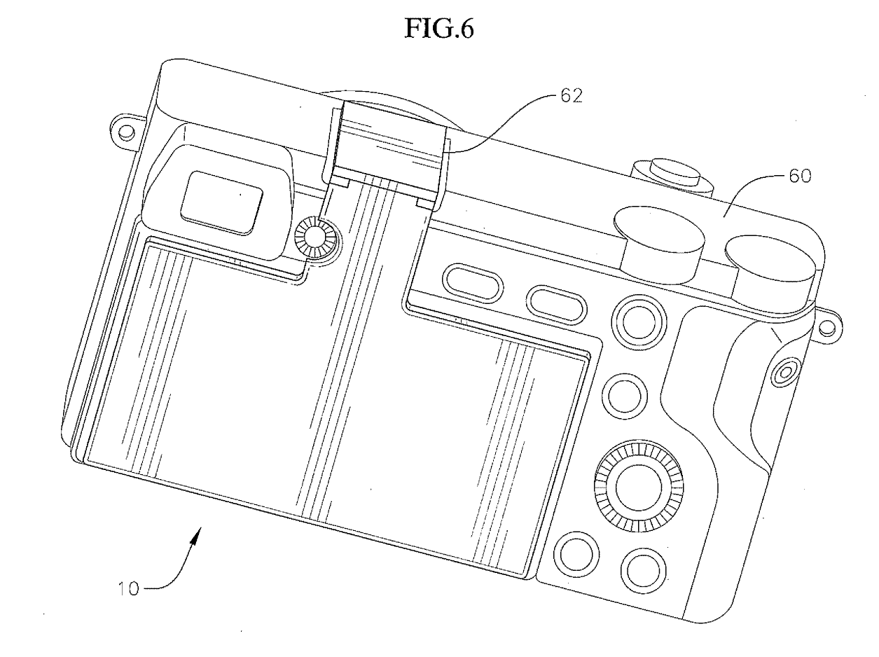

The use of the diffuser 10 will now be described primarily with reference to FIGS. 5 and 6. As will be appreciated, the diffuser is couplable to a camera in at least one of two orientations, a first orientation (FIG. 5) in which the diffuser is used to diffuse light from a camera flash (“diffuser use”), and a second orientation (FIG. 6) in which the diffuser is used as a screen cover and protector “screen cover use”.

FIG. 5 shows the diffuser 10 coupled to the hotshoe assembly 62 of the camera 60 in the first orientation. Particularly, in the first orientation the diffuser 10 can be slid, with the body 40 extending in a direction away from the camera 60, onto the hotshoe assembly 62 such that the top portion 66 of the side walls 64 is accommodated in the opposing channels 36 of the base 20 of the diffuser 10. Because the first and second flanges 24, 32 are relatively rigid, the base 20 of the diffuser 10 can thereby be secured to the hotshoe assembly 62 while the body 40 can be placed adjacent to or in front of the camera flash to diffuse light generated by the flash. Further, because the diffuser 10 is not directly coupled to the built-in camera flash, the built-in flash can be folded and stored as intended when it is not being used, even with the diffuser 10 attached to the camera 60.

As will be appreciated, the built-in flash on some cameras is located on an end of a rotatable frame such that light from the flash is generally directed in the direction in which the flash is facing. For example, when the flash extends upward from the body at a 45 degree angle, light is directed away at a 45 degree angle as well. For these types of cameras, the diffuser 10 may be placed in front of the flash such that the flash rests against the diffuser and such that light from the flash can be directed upward off the ceiling when resting against the diffuser.

With reference now to FIG. 6, the diffuser 10 can be oriented in the second orientation such that when it is slid onto the hotshoe assembly, the body 40 of the diffuser extends downward onto the camera 60, and particularly, wherein the body 40 covers the display screen of the camera. In one embodiment, the planar surface 42 of the body 40 directly contacts the screen to thereby cover and protect it. Because the diffuser 10 is anchored to the hotshoe assembly 62, it is difficult to separate the diffuser from the camera (other than by deliberately sliding it out), thereby ensuring protection for the display screen. Particularly, it would be difficult for a piece of equipment being jostled around in an equipment bag to dislodge the diffuser 10 when it is covering the display screen 68.

While this invention has been described in connection with what is presently considered to be practical exemplary embodiments, it is to be understood that the invention is not limited to the disclosed embodiments, but, on the contrary, is intended to cover various modifications and equivalent arrangements included within the scope of the appended claims, the detailed description of the invention, and the drawings.

What is claimed is:

1. A diffuser for a camera, the diffuser comprising:
a base configured to be accommodated on a hotshoe assembly of the camera;
a body configured to cover a display screen of the camera and also configured to act as a light diffuser; and
a bridge being directly coupled to and extending between the base and the body;
wherein the diffuser can be oriented in a first orientation in the hotshoe assembly such that the body extends away from the camera to act as a light diffuser or in a second orientation in the hotshoe assembly such that the body covers a display screen of the camera.

2. The diffuser of claim 1, wherein the body has a first surface that is planar and a second opposing surface that has at least one protrusion thereon.

3. The diffuser of claim 2, wherein in the second orientation the first surface of the body is configured to directly contact the display screen of the camera.

4. The diffuser of claim 1, wherein the base comprises a first plate, a second plate, and a block between the first and second plates, wherein a width of the first and second plates is greater than a width of the block.

5. The diffuser of claim 4, wherein outer longitudinal edges of the first and second plates define first and second flanges, respectively.

6. The diffuser of claim 5, wherein the first and second flanges and a portion of the block define a channel being configured to accommodate the hotshoe assembly.

7. The diffuser of claim 1, wherein the bridge is coupled to one longitudinal end of the base.

8. The diffuser of claim 1, wherein a longitudinal axis of the base extends in a first direction and a longitudinal axis of the body and the bridge extends in a second direction substantially perpendicularly to the first direction.

9. The diffuser of claim 1, wherein the diffuser forms an L-shape in cross-section.

10. The diffuser of claim 1, wherein the bridge has a notch configured to accommodate a protrusion on the camera body.

11. The diffuser of claim 1, wherein the diffuser is a single integral component.

12. The diffuser of claim 1, wherein the body is dimensioned to entirely cover the display screen of the camera.

13. The diffuser of claim 1, wherein peripheral edges of the body are configured to correspond to peripheral edges of the display screen.
